(19) United States
(12) Patent Application Publication
(10) Pub. No.: US 2008/0221967 A1
(43) Pub. Date: Sep. 11, 2008

(54) Attribute-Based Ordering System

(75) Inventors: Thomas Emil Jensen, Lyngby (DK); Philip Skov Knudsen, Hellerup (DK); Mads Lundemann, Rodovre (DK); Niels Teglsbo Jensen, Kastrup (DK)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/684,141

(22) Filed: Mar. 9, 2007

(51) Int. Cl. G06F 17/10; G06Q 10/00

(52) U.S. Cl. 705/10; 705/400

(57) ABSTRACT

By letting the needs of customers be specified by the corresponding resource attributes instead of specific resources, more customer needs can be met and the overall costs of assigning resources to customers can be minimized

### BACKGROUND

Efficient use of resources has long been a challenge to modern business. The efficient use of resources is complicated by having orders reserving a specific item or service number, which leaves little space for optimization. Often, when custom ers ask for an item or service, they really are asking for an item or service that has a number of attributes. By focusing on the satisfaction of these attributes, a better customer satisfaction and profit can be obtained than if orders were locked to specific items or services.

### SUMMARY

By specifying the attributes of items or services requested in an ordering system, it is possible to reassign items or services to other customers such that all customers get the attributes they request and such that the overall satisfaction and profit is maximized. A method may receive one or more attributes to be satisfied and the quantity of the resource desired. The method may quickly determine whether a resource exists that has the attributes desired and the quantity desired. If a resource exists, the method may at a later moment assign costs to the possible assignments of resources to customers and minimize the overall cost of meeting the desired attributes and quantities of all the customers.

### BRIEF DESCRIPTION OF THE DRAWINGS

FIG. 1 is an illustration of a computing device which displays the display objects;

FIG. 2 is an illustration of a flowchart of a method for determining whether the requested quantity of resources is available;

FIG. 3 is an illustration of a sample resource and its attributes;

FIG. 4 is an illustration of a method which supports placing an order;

FIG. 5 is an illustration of a method of optimizing the allocation of resources;

FIG. 6 is an illustration of a sample resource and its attributes and weights applied to the attributes; and

FIG. 7 is an illustration of three resources and their attributes.

### SPECIFICATION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, it not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

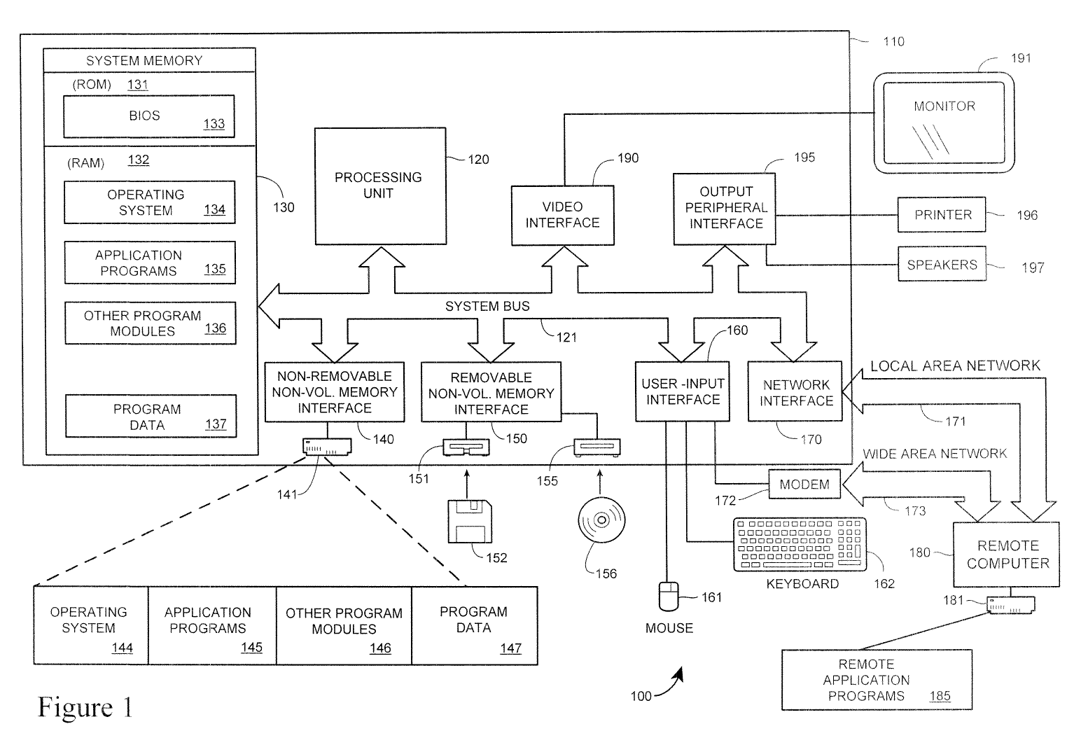

FIG. 1 illustrates an example of a suitable computing system environment 100 that may operate to display and provide the user interface described by this specification. It should be noted that the computing system environment 100 is only one example of a suitable computing environment and is not intended to suggest any limitation as to the scope of use or functionality of the method and apparatus of the claims. Neither should the computing environment 100 be interpreted as having any dependency or requirement relating to any one component or combination of components illustrated in the exemplary operating environment 100.

With reference to FIG. 1, an exemplary system for implementing the blocks of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120.

Computer 110 may operate in a networked environment using logical connections to one or more remote computers such as a remote computer 180, via a local area network (LAN) 171 and/or a wide area network (WAN) 173 via a modem 172 or other network interface 170.

Computer 110 typically includes a variety of computer readable media that may be any available media that may be accessed by computer 110 and includes both volatile and nonvolatile media, removable and non-removable media. The system memory 130 includes computer storage media in the form of volatile and/or nonvolatile memory such as read only memory (ROM) 131 and random access memory (RAM) 132. The ROM may include a basic input/output system 133 (BIOS). RAM 132 typically contains data and/or program modules that include operating system 134, application programs 135, other program modules 136, and program data 137. The computer 110 may also include other removable/non-removable, volatile/nonvolatile computer storage media such as a hard disk drive 141 a magnetic disk drive 151 that reads from or writes to a magnetic disk 152, and an optical disk drive 155 that reads from or writes to an optical disk 156. The hard disk drive 141, 151, and 155 may interface with system bus 121 via interfaces 140, 150.

A user may enter commands and information into the computer 20 through input devices such as a keyboard 162 and pointing device 161, commonly referred to as a mouse, trackball or touch pad. Other input devices (not illustrated) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device may also be connected to the system bus 121 via an interface, such as a video interface 190. In addition to the monitor 191, computers may also include other peripheral output devices such as speakers 197 and printer 196, which may be connected through an output peripheral interface 190.

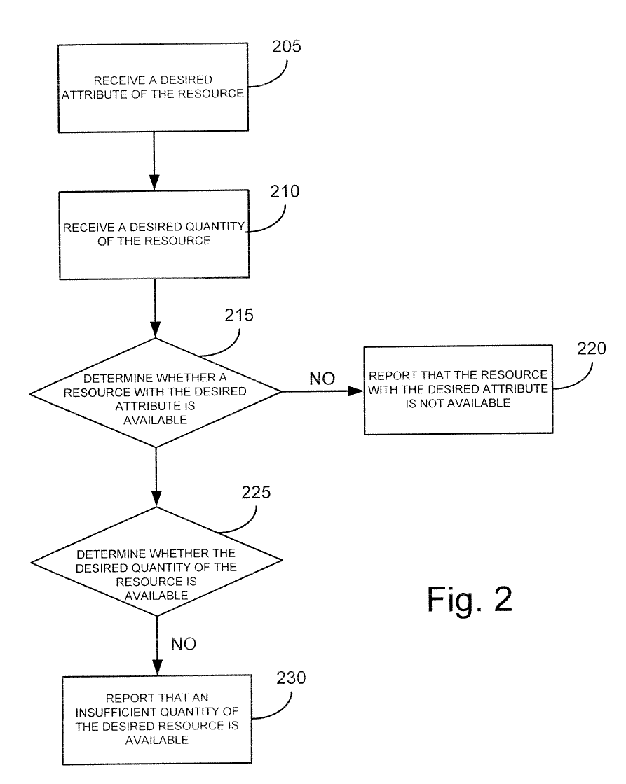

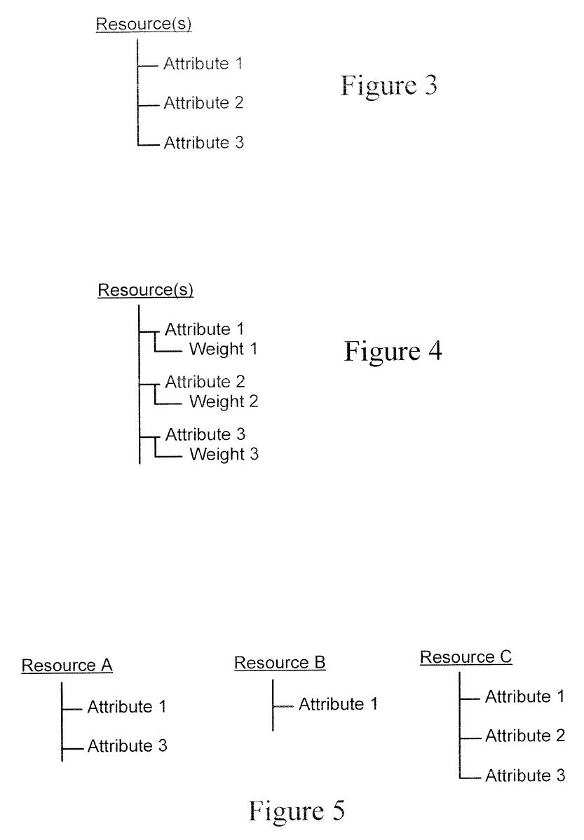

FIG. 2 is an illustration of a method of allocating a resource. A resource may be anything of desire to a consumer such as rooms in a hotel, golf courses in a community, a bolt, a screw, a casting, or virtually any product or service. In normal situation, a customer simply requests a resource. In the method described below, the customer may request attributes of a resource and not necessarily a resource. By selecting the attributes that the resource is to satisfy there may be a higher probability of pleasing the customer. FIG. 3 lay be a graphical illustration of a resource 300 that has several attributes 310, 320, 330.

At block 205, a desired attribute of the resource may be received. An attribute may be a feature of the resource. For example, in a hotel room, the attribute may be that the room has an ocean view or that the room be ADA accessible. As another example, attributes of a screw may be that the screw be at least three inches long, be made of a rust free material and be silver. Every product or service may have attributes that may be identified and requested. Yet another attribute may be the date on which the resource is available, and the delivery day of the order.

At block 210, a desired quantity of the resource may be received. For example, a customer may want one hotel room or 1,000 bolts. The quantity may be virtually any number and may even be used for “what if” purposes.

At block 215, the method may determine whether a resource with the desired attribute is available. By knowing the desired attribute, a quick check may be made to determine if any resources are available with the desired attribute. The method may also determine if resources may be freed to satisfy the desired attribute. For example, if a vendor has already accepted Order A which promised 500 bolts to another customer at a point in the distant future, those bolts may be freed for a more immediate order assuming there is sufficient time to obtain additional desired bolts to fulfill Order A, the 500 bolt order. In another example the vendor has accepted an Order B of 100 screws that were fulfilled by a resource of 100 silver screws. If another Order C demands 50 silver screws, and no more silver screws are available, the order can be satisfied by reassigning 50 silver screws from Order B to Order C, and letting order B get 50 ordinary screws. By moving the available resources based on attributes such as delivery dates and quantities, customers that previously may have been turned away may now be serviced.

One way to determine whether a resource with the desired attribute is available is to use an algorithm such as the Marriage algorithm. The Marriage Algorithm is based on Hall's theorem (Hall 1935). The standard example (somewhat dated at this point) of an application of the marriage theorem is to imagine two groups of n men and women. Each woman would happily marry some subset of the men; and any man would be happy to marry a woman who wants to marry him. Consider whether it is possible to pair up the men and women so that every person is happy.

It should be noted that if there exists a perfect pairing then it must be true that for any subset of the women the number of men that they collectively like must be at least as large as the number of women in the subset. For if this is not true then clearly a perfect matching is impossible. This is called the marriage condition or Hall's condition, discovered by Philip Hall in 1931. Hall proved that this obvious necessary condition is also sufficient to insure a perfect pairing.

In a graph representation the algorithm considers a graph G=(V, E) where all demands are represented as nodes d1, . . . , dm and all resources are represented as nodes r1, . . . , n1. There is source-node s and a sink-node t. An edge (di, rj) appears in the graph if and only if the attributes requested by demand i may be satisfied by the attributes associated with resource j. Moreover there are edges (s, di) for all demands, and edges (ri, t) for all resources. The problem is now to find a maximum flow from s to t in the graph G=(V, E). This can be solved using an augmenting path method like (Ford and Fulkerson 1962). In pseudo code, the algorithm may follow the following pseudo code:

Augmenting-Path(G)

| | |
|---|---|
| 1 | x := 0 |
| 2 | while augmenting path P exists in G(x) do step 3 to 5 |
| 3 | r: = residual capacity of P |
| 4 | augment r units of flow along P |
| 5 | update G(x) |
| 6 | return x |

In one implementation, a breadth first search is used to find the augmenting path in order to ensure that a minimum number of reassignments are made.

When new request or resources are added to the method, the graph may be simply extended with the new nodes and edges, and the augmenting path method may be warmstarted from the current solution x.

At block 220, if the determination at block 215 is no (that there are sufficient resources to satisfy the request), the method may report that the resource with the desired attribute is not available. In another embodiment the method may repost the maximum quantity that could have been made available, and allow the customer to modify the request in view of the number available. The customer may then cancel some attributes and see the quantity of resources ice that may be available based on the new attribute requirements. This “what if” process may be repeated until the user is satisfied. To support the customers search for attributes that are available, an overviews of available resources is shown for each attribute, as is the difference between the requested and available attributes quantities.

At block 225, if the determination at block 215 is yes (the desired quantity is available), the method may collect all instances of an available desired resource. The available desired resource may be is an instance of the resource that has the desired attribute and that can be made available or freed.

Collecting all instances of an available desired resource may be accomplished in a variety of ways. In one embodiment, the method may increment through the instances of the desired resource and may determine whether the instance of the desired resource can be made available by substituting another resource. For example, if a customer simply requests fasteners and both nails and screws may work, then screws may appear as available as nails may be substituted for screws. If the determination is yes, the instance of the desired resource may be added to a list of available resources. If the determination is no, the next instance of the resource may be reviewed.

FIG. 4 is an illustration of a method which supports the user in placing his/her orders. The method guides the user through the possible choices of attributes, ensuring that all shown resources actually are available or can be made available by reassigning other orders.

At block 400, it is assumed that the customer initially has not specified any attributes. In another embodiment the method may use some default or start attributes corresponding to the customer.

At block 405, the method displays all available product categories and their attributes. Moreover, the method shows the quantity of each resource that are available or can be made available that satisfied the given attribute and all previously requested attributes. In one embodiment of the method, the Marriage algorithm from FIG. 2 is used for each available attribute to determine the quantity of the resource that can be made available.

At block 410, the method asks the customer whether he/she relishes to finish the order. If the customer wishes to specify another attribute, the attribute is specified in block 415 and the above method is repeated. In one embodiment of the method, the customer may further choose to change or delete some previously specified attributes.

At block 420, the customer has finished specifying attributes and the customer is requested to input the quantity of the resources. If the order is similar to previous orders, a value from the previous order may be used. Default values may also be used. In addition, the quantity may be selected from a drop-down list of standard quantities.

At block 425, the method determines whether the requested quantity of resources with the desired attributes can be made available. If the determination at block 425 is no (an insufficient quantity of resources is available), the customer is asked to modify the attributes or quantity.

At block 430, the method has determined that a sufficient quantity of resources is available, hence the order is saved as a set of attributes and a quantity.

At block 435, the method updates the current assignment of resources to requests using the Marriage algorithm. In this way, inventory amounts will be accurate and kept up to date. In another embodiment of the method the customer may be asked for the quantity before the attributes. In yet another embodiment of the method the specification of quantity and attributes can be mixed. In a further embodiment of the method, the Marriage algorithm is not used in every step of the specification but previously calculated values of resources available are used in the dialogue.

FIG. 5 is an illustration of a method of optimizing the allocation of resources. In one embodiment, the method may be used before actually shipping the resources to the customers. In another embodiment, the method may be used when the resources are going to be ordered from the suppliers, or when the resources are going to be produced internally. In yet another embodiment, the method may be used before sending detailed order confirmations to the customers.

At block 500, the method may for all requests determine all resources that fulfill the requested attributes. In other words, the method detects all alternative assignments of resources.

At block 50, the method may assign a cost to all assignments of a resource to an order. Cost may be assigned in a variety of ways. Direct costs are usually known such as the cost to buy 100 nails, or the of shipping the nails from a given warehouse to the customer. Weak requirements of attributes, where a given attribute is desirable but not strictly demanded, may be handled by assigning costs to assignments of resources to orders which do not satisfy the desirable attribute. Other costs may be added in and may depend on the customer. For example, the cost of delivery may be included into the cost for some customers but not for others. The costs may be integral costs representing the vendors own preferences and expenses of using the resources. The external costs (the price of a resource) may be handled as ordinary attributes. The customer may specify that a resource may not cost more than a given amount of dollars. This attribute will be respected throughout all re-assignments. Many models are available for allocating direct and indirect costs and these methods are possible.

At block 510, the method may determine the minimum cost of providing the available desired resource for all instances of the available desired resource. In another embodiment, a minimum cost flow algorithm is used. The minimum cost flow problem finds the cheapest possible way of sending a certain amount of flow through a flow network.

Ahuja, Orlin, Magnanti (1993) proved that a feasible solution x to the minimum cost flow problem is optimal if and only if no negative-cost cycle can be found in the residual network. Further details can be found in “Network flows—Theory, Algorithms and Applications” published by Prentice Hall in 1993, which is incorporated by reference. This can be used to construct a cycle-canceling algorithm for solving the minimum-cost flow problem: As long as the algorithm finds negative-cost cycles, the flow along the cycle is augmented. This leads to the following pseudo-code

Cycle-Canceling Algorithm(G, c, u)

| | |
|---|---|
| 1 | (G(x), r):= establish a feasible flow x in G |
| 2 | while negative cycle exists in G(x) do step 3 to 5 |
| 3 | W:= identify negative cycle |
| 4 | w:= min{e ∈ W} re |
| 5 | (G(x), r):=augment w units of flow along W in G(x) |
| 6 | return x |

The running time of the above algorithm may be further improved by using a scaling algorithm proposed by Sokkalingham, Ahuja, Orlin (2000) which is incorporated by reference. Of course, other methods of determining a minimum cost may be possible.

At block 515, the method may store the minimum cost of providing the available desired resource.

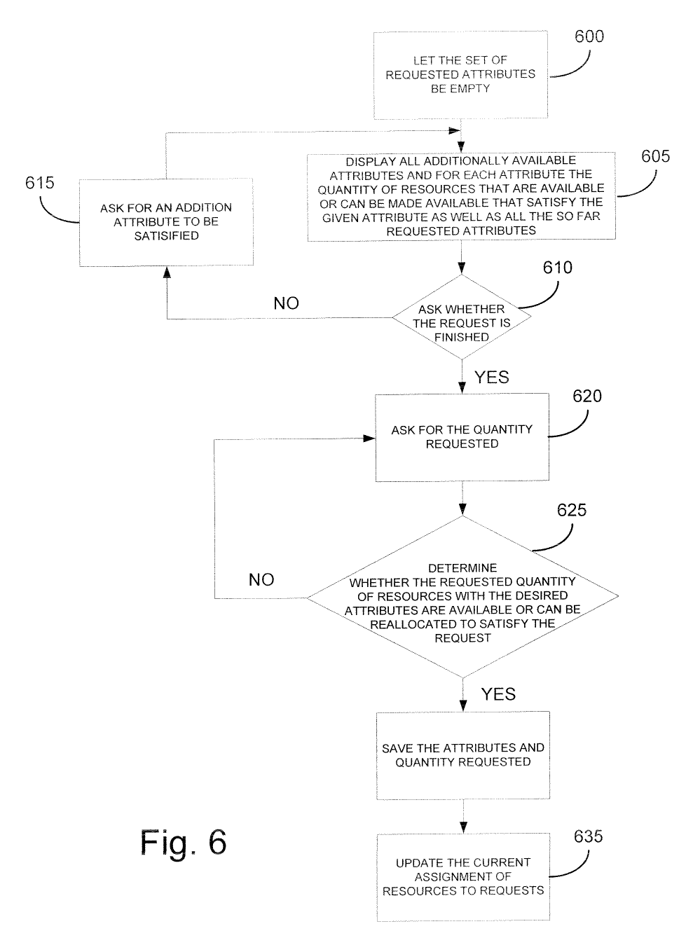

In another embodiment, the method may allow a user to add weights of importance to the desired attributes. FIG. 6 may be an illustration of one such embodiment. Weights are assigned to a given resource to a given customer. The weight may be the transportation cost or a measure of customer priority. In this way, the fact that some requests are more important than others (gold customers should be preferred, for example) may be taken into account. For example, there may be a first weight 610 applied to a first resource/customer combination, a second weight 620 applied to a second resource/customer combination and a third weight 630 applied to a third resource/customer combination. In this case, the method may attempt to maximize customer satisfaction by maximizing the weights of importance of the desired attributes using the weights 610, 620, 630.

In yet another embodiment, the method may allow levels of an attribute to be assigned to an attribute. For example, if the resource is a hotel room and the desired attribute is a view of the ocean, some rooms may have a better view of the ocean than others. This may be reflected in the weights applied to each attribute. For example, a 1-5 scale may be used where a high number reflects a better attribute. These weights also may be used to provide additional customer satisfaction.

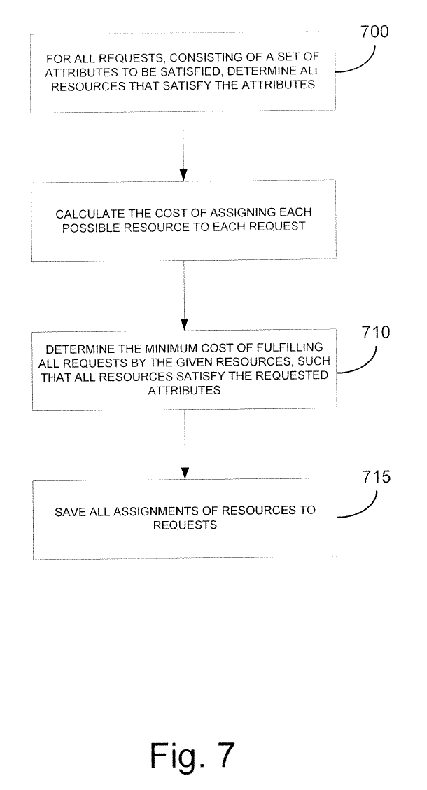

In practice, FIG. 7 may be an illustration of a sample embodiment. There may be a first resource 700, a second resource 705 and a third resource 710. The first resource 700 may have the first attribute 715 and the third attribute 720 but may be missing the second attribute. The second resource 705 may have the first attribute 725 but may be missing the second and third attribute. The third resource 710 may have the first attribute 730, the second attribute 735 and the third attribute 740. In one embodiment, the customer may request the second attribute. In this situation, only resource two 705 may meet this request.

In another situation, a customer may request attribute one. The method may determine the available resources by determining all the resource that may be able to be made available. In this example, resource one 700, resource two 705 and resource three 710 may meet this request. At this point, the method may assign costs to delivering resource one 700, two 705 and three 710. The method may then determine the lowest cost of supplying resource one 700, resource two 705 and resource three 710 and the lowest cost may be presented to the user.

In a further embodiment, the attributes for the first resource 700, second resource 705 and third resource 710 may be assigned weights that reflect the level of the attribute. These weights may be used to calculate various combinations. For example, some customers may desire the best satisfaction without regard to cost. Other customers may desire the lowest cost while other customers may desire a combination of satisfaction and cost. By reviewing the level of attributes of the resource, the weights used by the user and the costs assigned, all the goals may be calculated.

In a further embodiment, the vendor may wish to deliver the oldest resources first to his customers. This may be handled by assigning an attribute to the resources which states the expiration date. By looking at the expiration date, the system may assign slightly smaller costs to the oldest resources of a given type, to enforce solutions that use the oldest resources first.

In yet another embodiment, some resources may be produced continually or be replenished as deliveries depart. Instead of having a delivery date assigned to each resource, the system can handle continuous products where the quantity is represented as a piecewise linear function.

A further embodiment may handle that all resources delivered to a customer are same. If for instance an order consists of 100 screws, and the customer wishes that they have the same color and length, then the system is not allowed to mix different colors and lengths to satisfy the order. The handling of same orders make the problem difficult to solve, hence, the system makes use of a heuristic to solve these requests.

A further extension may be that orders are connected. If one order asks for 100 screws, and another order asks for 100 bolts, the two orders may be connected by indicating that the screws and bolts have to be the same color. Handling of connected orders makes the problem difficult to solve, and the system uses a heuristic approach to handle these requests. In a final embodiment it may be desirable that an order is satisfied using as few different resources as possible.

Using the method, customers can place orders using attributes, rather than requesting specific products. By fulfilling orders by looking at attributes, customer satisfaction may be raised and costs may be lowered by calculating the minim cost of providing the desired attributes while meeting the custotmer's needs.

1. A method of allocating, a resource comprising:
receiving a desired attribute of the resource;
receiving a desired quantity of the resource;
determining whether a resource with the desired attribute is available;
if the determination is no, reporting that the resource with the desired attribute is not available;
if the determination is yes:
determining whether the desired quantity of the resource is available;
if the determination is no, reporting that an insufficient quantity of the desired resource is available;
if the determination is yes:
storing the request as a set of attributes and the requested quantity;
collecting all instances of an available desired resource wherein the available desired resource is an instance of the resource that has the desired attribute and that can be made available;
assigning a cost to all the instances of the available desired resource of assigning the resource to the request;
determining the minimum cost of fulfilling all requests; and
storing the minimum cost of providing the available desired resource.

2. The method of claim 1, further comprising allowing cost to be an attribute and allowing cost to be set to a maximum value.

3. The method of claim 1 further comprising allowing a vendor to add weights of importance to the various assignments of items to customers.

4. The method of claim 1, wherein collecting all instances of an available desired resource further comprises:
reviewing an instance of the desired resource
determining whether the instance of the desired resource can be made available by reassigning the current allocation;
if the determination is yes
adding the instance of the desired resource to a list of available resources;
if the determination is no:
reviewing the next instance of the resource.

5. The method of claim 1, further comprising if the determination of whether the desired quantity of resources is available is no, displaying the amount available to a customer and allowing the customer to reduce the amount requested to be equal to or less than the amount available.

6. The method of claim 1, wherein the cost of providing the available resource includes indirect costs.

7. The method of claim 6, further comprising determining the profit for an instance of an available desired resource comprising:
determining the revenue from selling the instance of the desired resource;
determining the total cost of selling the instance of the desired resource; and
subtracting the total cost from the revenue to determine a profit amount for the instance of the desired resource.

8. The method of claim 1, wherein attributes comprise features of a desired resource.

9. A computer system comprising a processor for executing computer executable code, a memory for storing computer executable code and an input/output circuit, the processor being configured in accordance with the computer executable code, the computer executable code comprising code for:
receiving a desired attribute of a resource wherein attributes comprise features or the resource;
receiving a desired quantity or the resource;
determining whether a resource with the desired attribute is available;
if the determination is no reporting that the resource with the desired attribute is not available;
if the determination is yes:
determining whether the desired quantity of the resource is available;
if the determination is no, reporting that an insufficient quantity of the desired resource is available;
if the determination is yes:
collecting all instances of an available desired resource wherein the available desired resource is an instance of the resource that has the desired attribute and that can be made available;
assigning a cost to all the instances of the available desired resource including indirect costs;
determining the minimum cost of providing the available desired resource for all instances of the available desired resource; and
storing the minimum cost of providing the available desired resource.

10. The computer system of claim 9, the processor being configured in accordance with the computer executable code, the computer executable code further comprising code for allowing cost to be an attribute and allowing cost to be set to a maximum value.

11. The computer system of claim 9, the processor being configured in accordance with the computer executable code, the computer executable code further comprising code for allowing a vendor to add weights of importance to the various assignments of items to customers.

12. The computer system of claim 9, wherein the computer executable code for collecting all instances of an available desired resource further comprises computer executable instructions for:
reviewing an instance of the desired resource
determining whether the instance of the desired resource can be made available by substituting another resource;
if the determination is yes
adding the instance of the desired resource to a list of available resources;
if the determination is no:
reviewing the next instance of the resource.

13. The computer system of claim 9, further comprising if the determination of whether the desire quantity of resources is available is no, the computer executable code further comprising computer executable code for displaying the amount available to a customer and allowing the customer to reduce the amount requested to be equal to or less than the amount available.

14. A computer readable medium configured to store computer executable instructions for:
receiving a desired attribute of a resource wherein attributes comprise features of the resource;
receiving a desired quantity of the resource;
determining whether a resource with the desired attribute is available;
if the determination is no, reporting that the resource with the desired attribute is not available;
if the determination is yes:
determining whether the desired quantity of the resource is available;
if the determination is no, reporting that an insufficient quantity of the desired resource is available;
if the determination is yes:
collecting all instances of an available desired resource wherein the available desired resource is an instance of the resource that has the desired attribute and that can be made available;
assigning a cost to all the instances of the available desired resource including indirect costs;
determining the minimum cost of providing the available desired resource for all instances of the available desired resource; and
storing the minimum cost of providing the available desired resource.

15. The computer readable medium of claim 14, wherein the computer executable code for collecting all instances of an as available desired resource further comprises computer executable instructions for:
reviewing an instance of the desired resource
determining whether the instance of the desired resource can be made available by substituting another resource;
if the determination is yes
adding the instance of the desired resource to a list of available resources;
if the determination is no:
reviewing the next instance of the resource.

16. The computer readable medium of claim 14, further comprising computer executable code for determining the profit for an instance of an available desired resource comprising computer executable code for:
allowing a vendor to add weights of importance to the various assignments of items to customers.

17. The computer readable medium of claim 14, further comprising computer executable code for delivering the oldest items from inventory first.

18. The computer readable medium of claim 14, further comprising computer executable code for representing resources that are continuously replenished as a piecewise linear function.

19. The computer readable medium of claim 14, further comprising computer executable code for combining related order to be satisfied together.

20. The computer readable medium of claim 14, further comprising computer executable code for indicating that an attribute is not available and providing options for attributes that are available.
